(19) United States
(12) Patent Application Publication
(10) Pub. No.: US 2015/0101167 A1
(43) Pub. Date: Apr. 16, 2015

(54) STAPLE REMOVER

(71) Applicant: Yuning Jiang, Lexington, MA (US)

(72) Inventor: Yuning Jiang, Lexington, MA (US)

(21) Appl. No.: 14/050,672

(22) Filed: Oct. 10, 2013

(51) Int. Cl. B25C 11/02

(52) U.S. Cl. CPC B25C 11/02
USPC 29/426.5; 254/28

(57) ABSTRACT

A staple remover having a retractable pair of pliers is provided. The pair of pliers are capable of a retracted position and an extended position. In the extended position, the pliers may be used to remove a partially removed staple or staple fragment.

### BACKGROUND OF THE INVENTION

1. Field of the Invention

The present invention relates generally to staple removing devices. More particularly, the present invention relates to a staple removing device having retractable pliers to grasp a staple for removal.

2. Description of Related Art

A common office tool is a toothed, handheld, staple remover. This device has two opposing, pivot-mounted pairs of thin, steep wedges that resemble teeth, and a spring that returns the device to the open position. In use, the teeth are positioned adjacent to, or slightly under, the staple. When squeezed together, the teeth urge the staple upward and draw it out of its stapled position.

However, when extracting these staples, especially heavy gauge staples or staples in large documents, it is common for one of the sides of the staple to remain in the stacked papers. This causes users to try to use the toothed handheld staple remover as a grasping tool, which it is quite unsuited for. Another option is to grab the stuck staple end with a user's fingers, which is often uncomfortable and ineffective.

A further problem is created when the staple breaks during removal. In cases such as this, again the user can either try to pry it out with fingers or the ill-equipped toothed staple remover, or may pull the pages apart until the staple fragment can either be grasped, or eventually falls out.

Therefore, what is needed is a device that may effectively remove staples that may also effectively remove staples that are not fully removed and that may remove staple fragments.

### SUMMARY OF THE INVENTION

The subject matter of this application may involve, in some cases, interrelated products, alternative solutions to a particular problem, and/or a plurality of different uses of a single system or article.

In one aspect, a staple remover is provided. The staple remover comprises two opposing, pivot-mounted arms movable between an open and closed position. Each arm has a pair of thin, steep wedges spaced apart from each other at a distal end of the arm. A spacing is defined between the pair of wedges of each opposing arm. A spring is in communication with the two arms and biases the arms in the open position, the closing of the arms being against the force of the spring.

A pair of pliers is mounted within the spacings of the arms, one plier of the pair being in each of the two arms. The pliers are movable between a retracted position and an extended position. In varying embodiments, the pliers may be slideable, rotatable, or otherwise movable between the retracted position and extended position in any manner.

In the retracted position, the pliers are substantially retracted within the spacings of the two arms such that they are withdrawn entirely or nearly entirely within the spacings defined by the arms with no, or only a small portion of the pliers extending beyond the distal ends of the arms.

In the extended position, the pliers do extend beyond having a substantial portion of the pliers extending beyond the distal end of the two arms, allowing them to be used to grasp a staple or staple fragment.

### BRIEF DESCRIPTION OF THE DRAWINGS

FIG. 1 provides a perspective view of an embodiment of the staple remover.

FIG. 2 provides an elevation view of an embodiment of the staple remover with the pliers in a retracted position.

FIG. 3 provides an elevation view of an embodiment of the staple remover with the pliers in an extended position.

FIG. 4 provides a front view of an embodiment of the staple remover.

FIG. 5 provides an elevation view of another embodiment of the staple remover with the pliers in an extended position.

FIG. 6 provides an elevation view of yet another embodiment of the staple remover with the pliers in a retracted position.

FIG. 7 provides an elevation view of yet another embodiment of the staple remover with the pliers in an extended position.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a handheld, toothed, staple remover having a pair of integrated pliers to remove partially removed staples or staple fragments. The pliers are sized and configured to fit between a spacing defined between the pairs of opposing wedges. In some embodiments, these integrated pliers may be retractable.

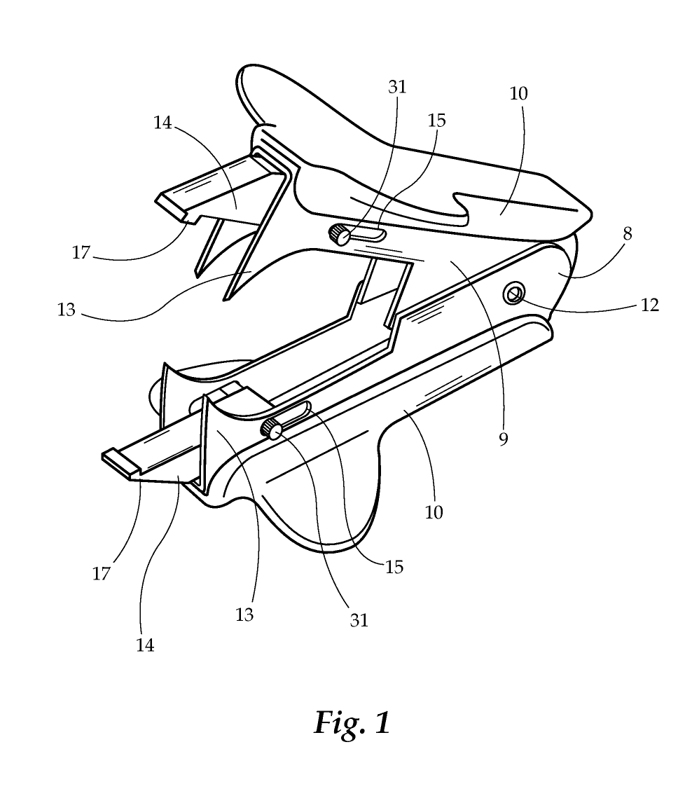

Turning now to FIG. 1, a perspective view of an embodiment of the present invention is provided. The traditional toothed, handheld, staple remover is shown formed by two arms 8, 9 pivotable about pin 12. A spring (not shown), or similar, works to bias the arms in an open position. Hand holds 10 extend over the outer surface of arms 8, 9 to provide an ergonomic interface for a user. The arms 8, 9, end with the pairs of opposing steep wedges (hereinafter referred to as “teeth”) 13. Between the spacing between the pairs of opposing teeth 13, opposing pliers elements 14 (collectively “the pliers 14”) are stored. In this embodiment, the pliers 14 are slideably retractable between an extended position for grasping a staple or staple fragment, and a retracted position for initially removing an in-place staple using the teeth 13. The pliers 14 are slidable along an aperture 15 defining a track along which the pliers 14 may move. This movement may be activated by knob 31, or similar. An end of each of the pliers 14 has an optional grasping protrusion 17 which allows a user to exert more force on a small surface area.

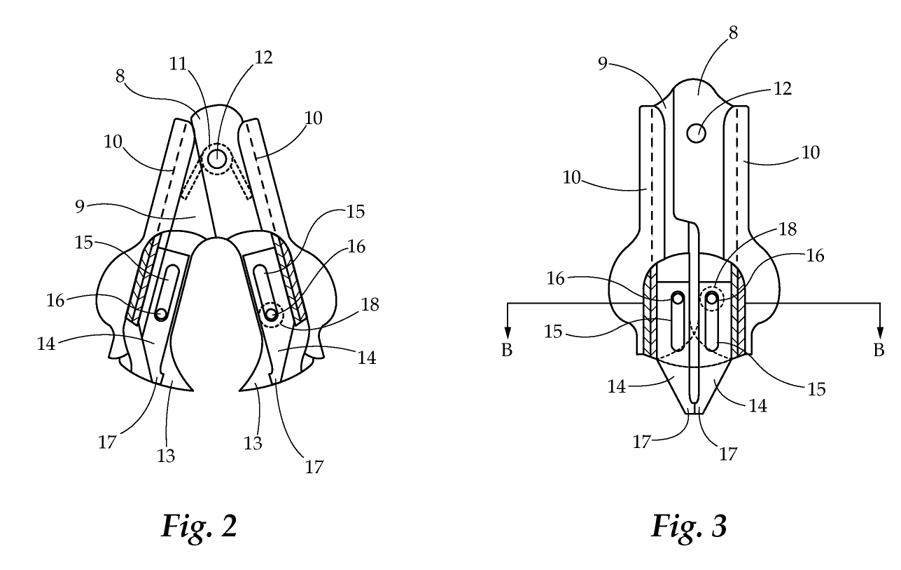

FIGS. 2 and 3 provide views of one embodiment of the present invention. FIG. 2 shows the embodiment in an open and retracted pliers position, while FIG. 3 shows the embodiment in a closed and extended pliers position. The traditional toothed, handheld, staple remover is shown formed by two arms 8, 9 pivotable about pin 12. A spring 11, or similar, works to bias the arms in an open position. Hand holds 10 extend over the outer surface of arms 8, 9 to provide an ergonomic interface for a user. The arms 8, 9, end with the pairs of opposing teeth 13. Between the spacing between the pairs of opposing teeth 13, opposing pliers 14 are stored. In this embodiment, the pliers 14 are slideably retractable between an extended position for grasping a staple or staple fragment, and a retracted position for initially removing an in-place staple using the teeth 13. The pliers 14 are slidable along an aperture 15 defining a track along which the pliers 14 may move, guided by pin 16. An end of each of the pliers 14 has an optional grasping protrusion 17 which allows a user to exert more force on a small surface area. In some embodiments, spacer 18 may be used to properly space the pliers 14 in the spacings relative to the teeth 13. In some embodiments, a staple remover may have the teeth 13 protruding from arm 9 configured to fit between the teeth 13 of arm 10. As such, a spacing between the teeth 13 of arm 10 will be bigger than a spacing between the teeth 13 of arm 9. In this embodiment, a spacer 18 may be needed on the plier 14 of arm 10 because of the larger spacing.

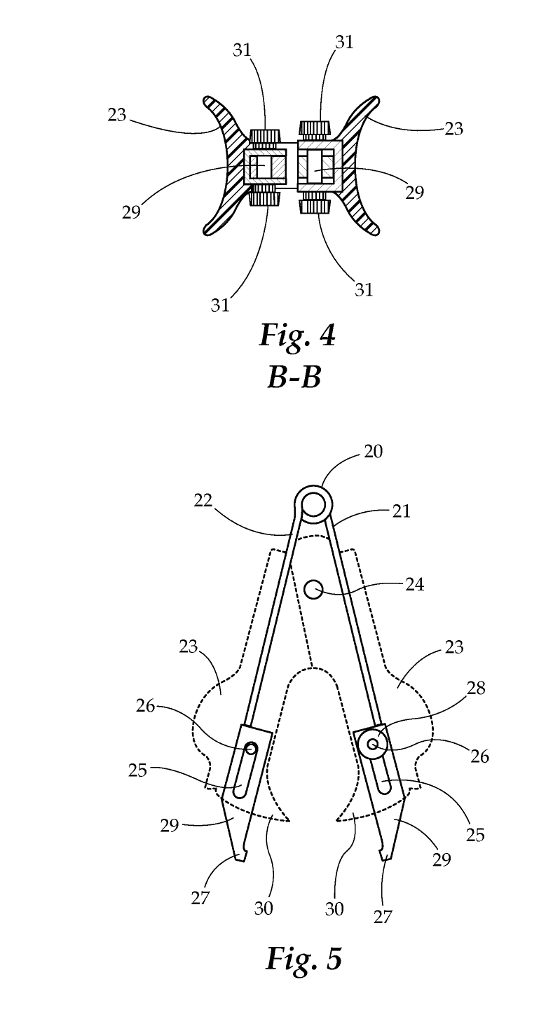

FIG. 4 shows a frontal view of an embodiment similar to that of FIGS. 2 and 3. In this embodiment, knobs 31 are used to slide the pliers 14 from a retracted to extended position. It should be understood that any mechanisms to retract or extend the pliers may be used. Further, in one embodiment, the pliers may be spring loaded. Handles 23 are formed to provide a gripping surface for the user. A front face 29 of each pliers 14 can be seen positioned between the spacings between the two sets of teeth 13.

FIG. 5 provides an elevation view of another embodiment of the present invention having a partial cutaway view. In this embodiment, the pliers 29 are retractable and extendable within the traditional style staple remover by a sliding of a spring linkage 20, 21, 22. In this embodiment, the spring linkage is formed of torsion spring 20 and linkage arms 21 and 22. Torsion spring 20 biases the staple remover arms 23 in an open position, as shown. As with the previous embodiment, the arms 23 each form a set of teeth 30. These arms 23 are connected together by, and pivotal about pin 24. Linkage arms 21 and 22 extend from torsion spring 20 and are slidably held within arms 23. Attached to the end of linkage arms 22, 21 are pliers 29. At an end of each plier is an optional protrusion 27 that may facilitate grasping of a staple to be removed. As in the previous embodiment, pliers 29 fit within the spacings between the set of teeth 30 of each arm 23. A spacer 28 may be used on one or both arms to properly position the pliers 29. Range of the sliding motion of the pliers 29, and correspondingly the spring linkage 20, 21, 22 is controlled, in this embodiment, by an aperture 25 formed in each plier 29 through which a pin 26 passes. The plier 29 is thus guidable by the pin along the space formed by the aperture 25. It should be understood however that in alternative embodiments, any method of controlling movement of the pliers 29 may be used, such as a track, blocking elements, and the like. In use, this embodiment may have the pliers 29 retracted to initially partially remove a staple, and if needed, the pliers can be extended using the spring linkage 20, 21, 22 and any staple or staple fragments can be grasped and removed.

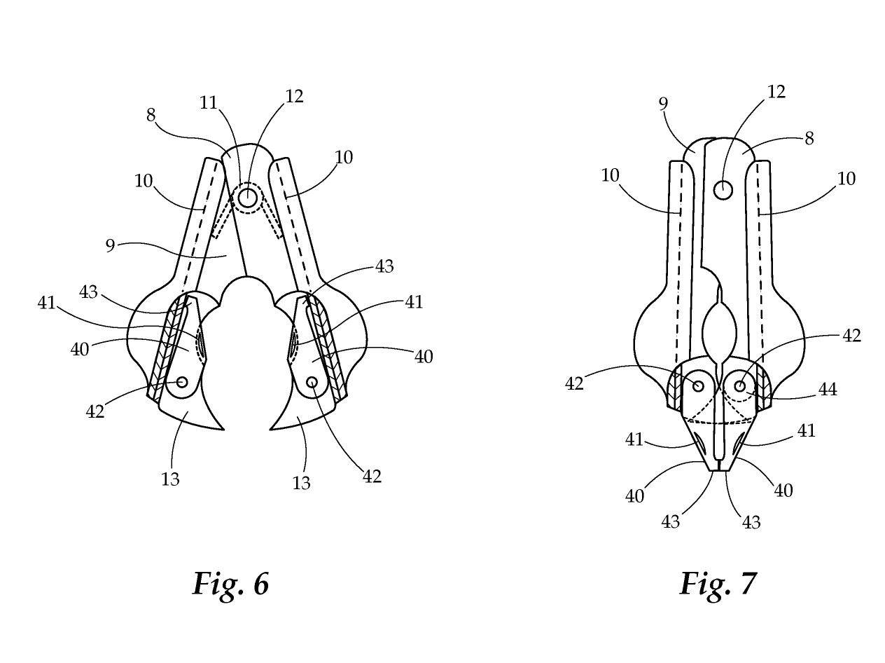

FIGS. 6 and 7 provide another embodiment of the present invention. In this embodiment, pliers 40 are pivotally retractable and extendable. In this embodiment, the staple remover comprises a traditional toothed, handheld staple remover shown formed by two arms 8, 9 pivotable about pin 12. A spring 11, or similar, works to bias the arms 8,9 in an open position. Hand holds 10 extend over the outer surface of arms 8, 9 to provide an ergonomic interface for a user. The arms 8, 9, end with the pairs of opposing teeth 13. Between the pairs of opposing teeth 13, opposing pliers elements 40 (collectively “the pliers 40”) are stored.

Pliers 40 are rotatable from a retracted position shown in FIG. 6, to an extended position shown in FIG. 7. The pliers 40 are rotatable about pin 42. Divots 41 facilitate grasping of the pliers 40 by a user. For example, divots 41 may be sized to allow a user to insert a fingernail or finger tip to ease the movement of the pliers 40. At an end of each plier 40 is a protrusion 43 that may facilitate grasping of a staple to be removed. In some embodiments, a spacer 44 may be used to properly position plier 40 within the spacing between the teeth 13.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A staple remover comprising:
two opposing, pivot-mounted arms, each arm having a pair of thin, steep wedges spaced apart from each other at a distal end, the pair of wedges of each opposing arms defining a spacing, the arms being pivotable between an open and closed position;
a spring that biases the arms in the open position;
a pair of pliers slideably mounted within the spacing of each arm defined by the pair of wedges, each plier having a front face facing the front face of the opposing plier, the pliers slideably movable between a retracted position having the pliers substantially retracted within the spacings of the two arms, and an extended position having a substantial portion of the pliers extending beyond the distal end of the two arms.

2. The staple remover of claim 1 wherein each of the pliers is slideable along a track defined by an aperture in each of the pliers and a pin connected to each arm and slideably positioned within the aperture.

3. The staple remover of claim 1 further comprising a spacer between one of the pliers and one of the pair of wedges.

4. The staple remover of claim 1 further comprising a knob in communication with each of the pliers on a side of each of the pliers.

5. The staple remover of claim 1 wherein the spring is a torsion spring linkage, and wherein the torsion spring linkage comprises a torsion spring, a first linkage arm and a second linkage arm, the first and second linkage arms attaching to the pair of pliers, while the torsion spring is positioned extending past proximal ends of the two arms, wherein the torsion spring linkage is slideable, allowing the pliers to move between the extended position and retracted position.

6. The staple remover of claim 1 wherein each of the pliers further comprises a protrusion at a distal end of the pliers extending from the front face of each plier.

7. The staple remover of claim 1 wherein the pair of wedges of a first of the two arms are spaced apart such that the pair of wedges of the second of the two arms may fit between them.

8. The staple remover of claim 1 wherein the two arms are formed of a metal.

9. The staple remover of claim 1 wherein the pair of pliers are formed of a metal.

10. A method of using the device of claim 1 comprising the steps of:
partially removing a staple from a plurality of stapled-together pages;
extending the pair of pliers from the retracted position to the extended position;
grasping the partially removed staple using the pliers; and
fully removing the staple using the pliers.

11. A staple remover comprising:
two opposing, pivot-mounted arms, each arm having a pair of thin, steep wedges spaced apart from each other at a distal end, the pair of wedges of each opposing arms defining a spacing, the arms being pivotable between an open and closed position;
a spring that biases the arms in the open position;
a pair of pliers rotatably mounted within the spacing of each arm defined by the pair of wedges, the pliers rotatably movable between a retracted position having no portion of the pliers extending beyond the distal end of the two arms, and an extended position having a portion of the pliers extending beyond the distal end of the two arms.

12. The staple remover of claim 11 wherein each of the pliers are rotatable about a pin, each pin being connected to one of the two arms.

13. The staple remover of claim 11 further comprising a spacer between one of the pliers and one of the pair of wedges.

14. The staple remover of claim 11 wherein each plier defines a divot on its outer surface.

15. The staple remover of claim 11 wherein each of the pliers further comprises a protrusion at a distal end of the pliers extending from a front face of each plier, the front face of each plier being a face that faces the opposing plier when in an extended position.

16. The staple remover of claim 14 wherein each of the two pivot mounted arms defines a recessed portion allowing access to the divots of the pair of pliers when in a retracted position.

17. The staple remover of claim 11 wherein the pair of wedges of a first of the two arms are spaced apart such that the pair of wedges of the second of the two arms may fit between them.

18. The staple remover of claim 1 wherein the two arms are formed of a metal.

19. The staple remover of claim 1 wherein the pair of pliers are formed of a metal.

20. A method of using the device of claim 11 comprising the steps of:
partially removing a staple from a plurality of stapled-together pages;
extending the pair of pliers from the retracted position to the extended position;
grasping the partially removed staple using the pliers; and
fully removing the staple using the pliers.
